(19) United States
(12) Patent Application Publication
(10) Pub. No.: US 2007/0046034 A1
(43) Pub. Date: Mar. 1, 2007

(54) Foot bolt for a sliding door or similar

(76) Inventor: Jouko Urpolahti, Pori (FI)

Correspondence Address: STITES & HARBISON PLLC, 1199 NORTH FAIRFAX STREET, SUITE 900, ALEXANDRIA, VA, 22314, US

(21) Appl. No.: 10/582,715

(22) PCT Filed: Sep. 12, 2003
(86) PCT No.: PCT/FI03/00666

§ 371 Date: Jun. 12, 2006

(51) Int. Cl. E05C 1/02

(52) U.S. Cl. 292/137

(57) ABSTRACT

A foot bolt (10) of a sideways movable sliding door or a similar element (1-3), comprising a part locking the element in the base, such as a pin fitting in the hole in the base and which foot bolt construction further comprising a counterpart (9) in the next element movable beside it, in which counterpart the part (13) in the edge of the preceding element can be fitted so that the adjacent elements get sideways interlocked and that on moving the elements in the opposite direction pushing the last brought element from beside the preceding element opens the locking of the preceding element from the base. The pin fitting in the hole in the base is intended to be manually pressed for instance by the foot in the hole.

The invention relates to a foot bolt of a sideways movable sliding door, a wall, a sliding window or a similar element, the foot bolt comprising a part locking the element in the base, such as a pin fitting in the hole in the base and also comprising a counterpart in the next element movable beside it, in which counterpart the part in the edge of the preceding element can be fitted so that the adjacent elements get sideways interlocked and that on moving the elements in the opposite direction pushing the last brought element from beside the preceding element opens the locking of the preceding element from the base.

Previously known are foot bolt constructions as described among others from U.S. patent publication 6108989, DE published applications 4428718 and 19634390. In all of them as solution an automatic foot bolt is presented always placed in the move preceding element in its edge against which the next element is moved. The foot bolt has a pin fitting in the hole in the base, the sliding wall of which pin moved as the next contact makes by means of different gears sink down into the hole in the base. The solutions include that on moving walls away the removal of the preceding element releases the foot bolt pin in the next element up from the hole in the base.

Such a solution is easily produced but in practice the solution works only in connection with most accurately controlled elements, for which the holes in the base are just in positions according to the elements. In these solutions pushing the next element as extension of the preceding one the locking of the edge of the preceding element takes place only when the next element is pushed into contact. Accordingly, there is then nobody to secure that the pin takes its place in the hole in the base.

The weakness of these solutions is that on moving high elements, such as those of 2,5-3 meter height, while only from their upper edge in slide suspension, the elements do not at all hang by themselves so accurately that in the bottom edge a pin, for instance with a diameter of about 10 mm would hit a hole with a diameter of about 15 mm. In spaces where such closing walls are used there are often so much air flows that the elements simply swing. Under those circumstances it is impossible in the practice that automatic locking would work nearly in ways corresponding to one another according to solutions represented in the publications.

The aim of the invention is to produce a foot bolt, the function of which is reliable, its locking quickly done and its opening automatic, when walls are moved. The invention is characterized in that the pin fitting in the hole in the base is meant to get manually pressed with the foot into the hole, and the bolt construction comprises a locking/release pin, which in the first stage is arranged to lock the pressed-down pin in the hole in the base, and directed towards the next element the pin has a bracket, for which there is in the next element a counter-hole for interlocking and that the locking/release pin is arranged to stick out from the element edge so that it can with the next close beside the preceding brought element be pushed into a pin releasing position, whereby he pin is individually, for instance by a spring, arranged to get up from the hole in the base, when the adjacent element is removed.

The advantage of the foot bolt according to this invention is that when a separate wall is in its turn pushed to the position intended for it, it can be controllably steered to its place and at the same time simply stamp the locking pin down. The staying put of the element is easily secured and the pin position is easily seen, whether it has the possibility to get into the hole at the time. In the solution you need not to bend, since locking, that is stamping down the pin is most suitably done by foot. The next element to be brought into contact tunes-up the foot bolt so that it opens automatically, when starting to remove elements. The solution according to the invention can be used both for small size elements and especially for large ones.

In the following the invention is disclosed referring to the enclosed drawing, where

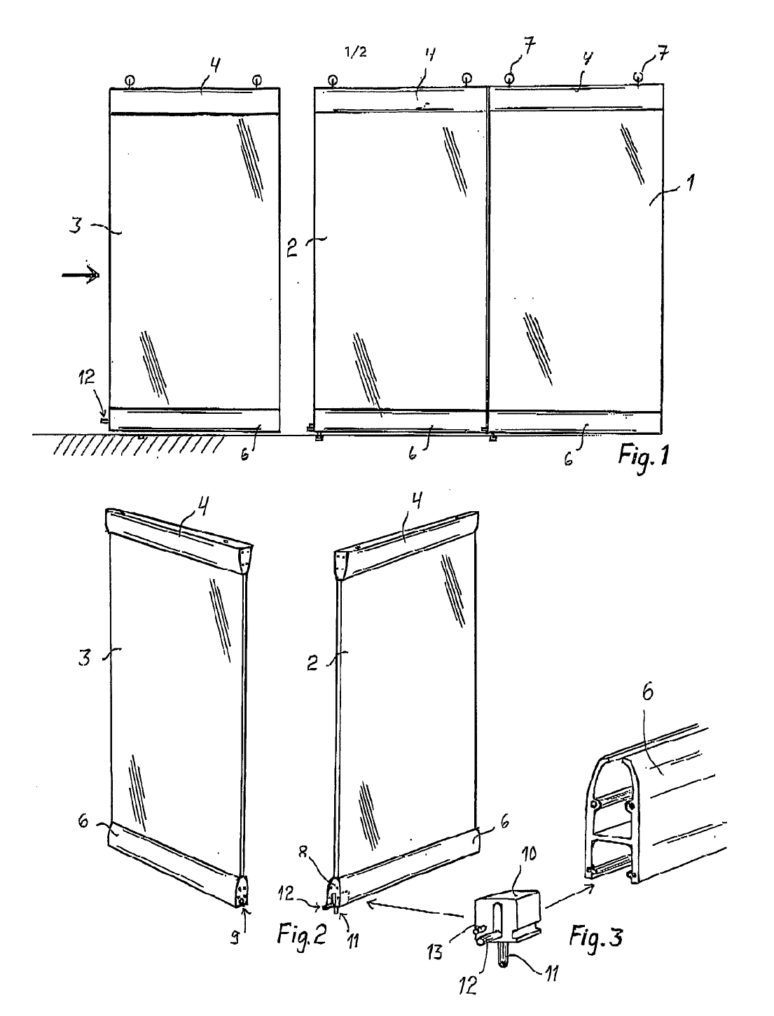

FIG. 1 shows sliding fit glass elements from the side.

FIG. 2 shows fit glass elements, edge profile and the foot bolt.

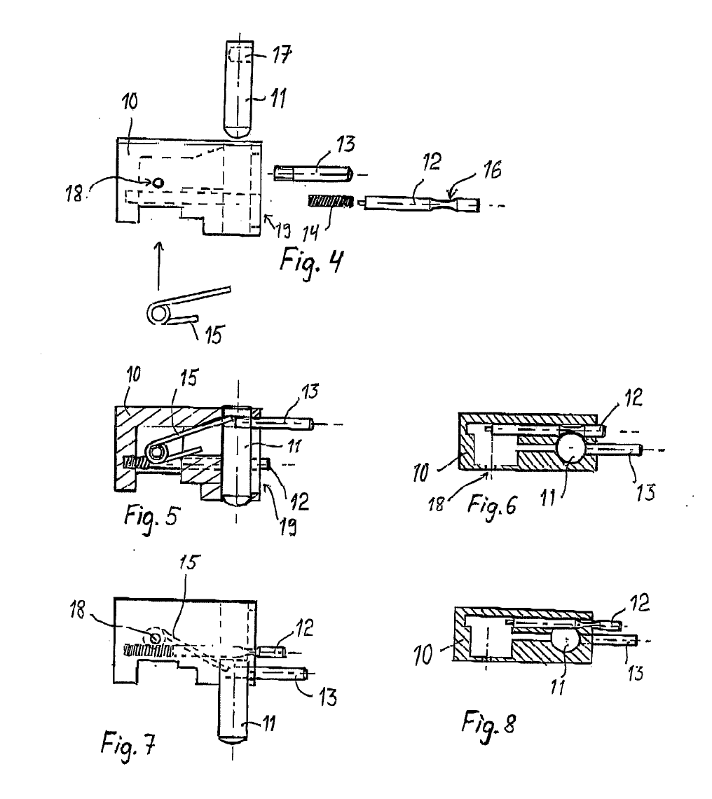

FIG. 4 shows the foot bolt from the side partly broken up.

FIG. 5 shows the foot bolt cut with the pin up.

FIG. 6 shows the boot bolt of FIG. 5 cut from above

FIG. 7 shows the foot bolt cut with the pin down.

FIG. 8 shows the boot bolt of FIG. 7 cut from above

In FIG. 1 elements 1-3 installed by means of rolls to be moved in the upper fixing rail, by means of which elements a broad corridor space, for instance, can if necessary be closed. In the bottom edge of the glass sheet there are edge strips 4 and 6 made of aluminium. The elements are linked in order to form a uniform wall.

In FIG. 2 the elements are shown diagonally, whereat also in FIG. 3 profile form 6 of the bottom edge is shown, in the end of which foot bolt 10 can be fitted. In the other end of profile 6 foot bolt 10 is fitted and in the other end is the profile-locking end piece furnished with hole 9 fitted. When element 3 is moved in contact beside element 2 the pin 12 of element 2 foot bolt gets into hole 9 in the end of element 3. The downwards pin 11 of foot bolt 10 is positioned in the hole in the bottom as illustrated also in FIG. 1.

FIG. 4 shows the foot bolt construction schematically. The upwards movable locking pin 11 is pushed into hole in foot bolt 10 hole and from the oblong hole 19 in the side of the body the threaded head of the sideways directed bracket 13 is pushed towards the pin and screwed into hole 17 in pin 11. For pin 11 a travel distance determined by the oblong side hole 19 is formed. Spring 15 is placed inside body 10, whereat it strives by means of its springback factor to keep pin 11 in upper position. Spring 15 is fitted into its housing by means of a shaft (not shown), which is pushed from hole 18 and runs through the spring eye. There is in body 10 for locking/release pin 12 a hole fitted with respect to the of hole pin 11 that they intersect partly. Spring 4 pushes pin 12 outwards and, furthermore, pin 12 has a thinning spot 16 so that when the thinning spot is on the line of pin 11, pin 11 can move vertically.

FIG. 5 is a crosscut view of body 10. Spring 15 keeps pin 11 up. The thinning spot is on the line of pin 11. When the element is moved by pressing it by foot to its place in order to lock bracket 13, whereat pin 11 gets into the hole in the base and also remains in the lower position, since pin 11 has been pressed so much down that locking/releasing pin 12 has according to FIGS. 7 and 8 come out a little pushed by its spring 14 and its pin portion of even thickness has moved partly over pin That is why pin 11 remains in lower position.

When the next element is brought closed beside the preceding one, there is in the edge of profile 6 of the element to be the brought a cover an a hole 9. The cover hits locking/releasing pin 12 and pushes it into the body, bracket 13 gets into position in cover hole 9. When cover hole 9 is loose or slightly oblong lengthwise bracket 13 and pin 11 can get up a little by the force of spring 15, and when thinning point 16 of pin 12 is now on the line of pin 11 this pin 11 gets up crosswise with thinning point 16 of pin 12 (oblong hole 9 allows raising) so much that it gets locked into position that releases pin 11. Bracket 13 is still in hole 9 and pin 11 is still in the hole in the base, whereby the element is locked to the base at the foot bolt and both sideways and in moving direction and even the other end of the element's lower edge is locked sideways. The ends of the lower edge profile 6 of each element have a hole 9 and cover in one end and foot bolt 10 in other end. Foot bolt body 10 is most suitably formed to be pushed directly into profile 6 according to FIG. 3.

When elements 1-3 are moved away in the opposite direction the move of element causes that foot bolt 11 of the next element gets up by force of the spring 15 immediately Thus the next element is automatically opened from locking and can be moved away as the other ones left behind.

By means of the foot bolt solution the moving and locking of elements to their places can be reliably carried out, since the element is handled and controlled manually till the locking. Locking can in no way be opened from the outside of the wall and no steering rails need to be arranged for the elements, only a series of holes on the line and at proper distances from one and other.

1. A foot bolt of a sideways movable sliding door, a wall, a sliding window or a similar element, (1-3 ) the foot bolt (10) comprising a part locking the element in the base, such as a pin fitting in the hole in the base and also comprising a counterpart (9) in the next element movable beside it, in which counterpart the part (13) in the edge of the preceding element can be fitted so that the adjacent elements get sideways interlocked and that on moving the elements in the opposite direction pushing the last brought element from beside the preceding element opens the locking of the preceding element from the base, characterized in that the pin (11) is intended to be manually pressed for instance by the foot in the hole, and the foot bolt construction comprises a locking/releasing pin (12), which in the first phase is fitted to lock pin (11) pressed down in the hole in the base, and pin (11) comprises a bracket (13) directed towards the next element and having in the next element a counter hole (9) for interlocking and that locking/release pin (12) arranged to stick out from the element edge so that it can with the next element to be brought closed beside the preceding element be the pushed into a pin (11) releasing position, whereby the pin is individually, for instance by a spring, arranged to get up from the hole in the base, when the adjacent element is removed.

2. A foot bolt according to claim 1, characterized in that there is for bracket (13) of the pin (11) a loose or a little oblong hole (9) in the latter element so that while said element is pushing pin (12) this pin (12) moves into a position that releases pin (11) and allows pin (11) to rise a little, and in its turn moves into a pin (12) releasing position to a maintaining stage, whereat removal of said element opens the locking, when bracket (13) and the pin (11) are released to rise off the locking position.

3. A foot bolt according to claim 1, characterized in that the axial path of locking/release pin (12) is arranged to partly cut the path of the pin (11) and the pin (12) has a thinning (16), which having been moved to the line of the pin (11) is outside the path of the pin (11).

4. A foot bolt according to claim 1, characterized in that the foot bolt construction body (10) and pins (11),(12),(13) of the foot bolt construction are placed in the backside when viewing the element in the in the direction of its position.
